(19) United States
(12) Patent Application Publication
(10) Pub. No.: US 2017/0307104 A1
(43) Pub. Date: Oct. 26, 2017

(54) Positioner and Valve Control System

(71) Applicant: Azbil Corporation, Tokyo (JP)

(72) Inventor: Seiji MORI, Tokyo (JP)

(73) Assignee: Azbil Corporation, Tokyo (JP)

(21) Appl. No.: 15/492,402

(22) Filed: Apr. 20, 2017

(30) Foreign Application Priority Data
Apr. 21, 2016 (JP) 2016-085218

(51) Int. Cl. F16K 37/00; H04W 4/00

(52) U.S. Cl. CPC F16K 37/0083; H04W 4/008

(57) ABSTRACT

A positioner has an electro-pneumatic converter that supplies a pneumatic signal obtained by converting an electrical signal for designating a valve opening of a control valve to operate a valve shaft, a valve-shaft position detection unit that detects a position of the valve shaft, and a control signal generating unit that generates the electrical signal based on a valve opening target and the position of the valve shaft. The positioner includes a first communication unit performing communication with the host device, a second communication unit performing communication with at least one sensor for monitoring the peripheral environment of the control valve by wireless communication, and a communication controller that controls the first communication unit to transmit information on the peripheral environment acquired from the sensor by the second communication unit through the first communication unit to the host device.

### CROSS-REFERENCE TO RELATED APPLICATIONS

The present application claims the benefit of and priority to Japanese Patent Application No. 2016-085218, filed on Apr. 21, 2016, the entire contents of which are incorporated by reference herein.

### TECHNICAL FIELD

The present disclosure relates to a positioner controlling a valve opening of a control valve and a valve control system including the positioner.

### BACKGROUND

A positioner has been hitherto used as an apparatus for controlling a valve opening of a control valve used for flow rate control in a chemical plant and the like.

The positioner controls the valve opening of the control valve by calculating a deviation between a setting value of the valve opening of the control valve designated by an apparatus management system (host device), such as a distributed control system (DCS) in a valve control system, and a measured value of the valve opening of the control valve, and by supplying a control signal generated based on the deviation to an operating device for operating opening/closing of the control valve.

In recent years, positioners having various diagnosis functions, such as a valve diagnosis function of determining the existence of an abnormality in the control valve and a self-diagnosis function of determining the existence of an abnormality in the positioner itself, in addition to the function of controlling the valve opening of the control valve have been proposed (for example, refer to Patent Literatures 1 and 2).

### CITATION LIST

### Patent Literature

[Patent Literature 1] JP-A-2012-207756

[Patent Literature 2] JP-A-2012-211599

### SUMMARY

The present inventors have considered that it would be useful for improvement in the control of a control valve and in corresponding diagnosis functions if not only operation states of the control valve and the positioner itself are monitored as in related art, but also information on the peripheral environment of the control valve, such as the existence of gas leakage, an ambient temperature, and a magnitude of vibration of the control valve, can be acquired in the valve control system including the control valve and the positioner.

In view of the above, as a result of studies by the present inventors concerning a system for constantly monitoring the peripheral environment of a control valve, it has been found that there are the following problems.

It is necessary to install various types of sensors on the periphery of the control valve for constantly monitoring the peripheral environment of the control valve. However, it is not preferable to install these sensors inside the positioner because the review of a structure of the positioner causes the increase of development man-hour and the increase of power consumption in the positioner.

It is desirable that detection results of the respective sensors are aggregated to the host device, such as the distributed control system (DCS) in the valve control system. However, it is necessary to allow the respective sensors to have communication functions corresponding to communication protocols requiring authentication, such as HART (Highway Addressable Remote Transducer) communication, to perform transmission/reception of data by the respective sensors via communications with the host device, which requires the sensors to be highly functional and incurs cost increase.

In the case where the respective sensors perform transmission/reception of data via independent communications with the host device, problems such as a delay in an updating cycle of information may occur due to the increase in communication traffic.

Furthermore, the host device is generally installed at a place apart from the control valve. Therefore, distances between the respective sensors installed around the control valve and the host device are long. Accordingly, it is difficult to perform communications between the respective sensors and the host device by wireless communication, and it is not realistic to perform communications by wired communication because the routing of wiring and the like becomes complicated.

The present disclosure has been made in view of the above problems and an object of the present disclosure is to realize a system capable of collecting information on the peripheral environment of a control valve and transmitting information to a host device efficiently at lower costs.

A positioner (1) according to the present disclosure has: an electro-pneumatic converter (13), which converts an electrical signal (MV) for designating a valve opening of a control valve (2) into a pneumatic signal (So) and supplies the pneumatic signal to an operating device (2A) of the control valve to operate a valve shaft (2B) of the control valve (2); a valve-shaft position detection unit (14), which detects a position of the valve shaft (2B) of the control valve (2); and a control signal generating unit (21), which generates the electrical signal (MV) based on a valve opening as a target of the control valve (2) and the position of the valve shaft (2B) of the control valve (2) detected by the valve-shaft position detection unit (14) and inputs the electrical signal (MV) to the electro-pneumatic converter (13). The positioner (1) further includes a first communication unit (11) performing communications with a host device (3), a second communication unit (12) performing communications with at least one sensor (5_1 to 5_4) for monitoring the peripheral environment of the control valve (2) by wireless communication, and a communication controller (20) connected to the first communication unit (11) and the second communication unit (12) and controls the first communication unit (11) to transmit information on the peripheral environment acquired from the at least one sensor (5_1 to 5_4) by the second communication unit (12) from the first communication unit (11) to the host device (3).

In the above positioner (1), the communication controller (20) may control the first communication unit (11) to transmit the information on the peripheral environment to the host device (3) with information concerning control of the control valve (2).

In the above positioner (1), the communication controller (20) may control the first communication unit (11) to transmit the information on the peripheral environment to the host device (3) in synchronization with timing of transmitting the information concerning control of the control valve (2) to the host device (3).

The above positioner (1) may further include a diagnosis unit (22) performing diagnoses of the control valve (2), in which the information concerning control of the control valve (2) includes diagnosis results by the diagnosis unit (22).

In the above positioner (1), the diagnosis unit (22) may further diagnose the peripheral environment of the control valve (2) based on the information on the peripheral environment acquired by the second communication unit (12).

A valve control system (100) according to an embodiment of the present disclosure includes: the above positioner (1); a control valve (2), a valve opening of which is controlled by a pneumatic signal from the positioner (1); a host device (3) connected to the positioner (1) via a communication line and performing transmission/reception of data with respect to the positioner (1); and at least one sensor (5_1 to 5_4) connected to the positioner (1) via a wireless channel and monitoring the peripheral environment of the control valve (2).

In the above explanation, reference numerals and signs on the drawings corresponding to components of the invention are written as examples with brackets.

As described above, it is possible to realize a system capable of collecting information on the peripheral environment of a control valve and transmitting the information to a host device efficiently at lower costs according to embodiments of the invention.

### BRIEF DESCRIPTION OF THE DRAWINGS

FIG. 1 is a diagram showing a configuration of a valve control system including a positioner according to an embodiment of the present disclosure.

FIG. 2 is a diagram showing a configuration of the positioner according to an embodiment of the present disclosure.

FIG. 3 is a flowchart showing the flow of transmission processing of sensor detection results and peripheral environment diagnosis results by the positioner according to an embodiment of the present disclosure.

### DETAILED DESCRIPTION

Hereinafter, an embodiment of the present disclosure will be explained with reference to the drawings.

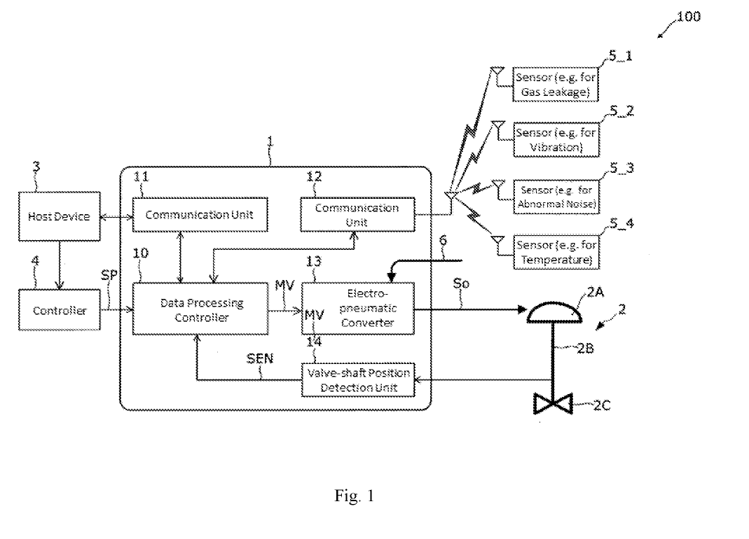

FIG. 1 is a diagram showing a configuration of a valve control system including a positioner according to an embodiment of the present disclosure.

A valve control system 100 shown in FIG. 1 includes a control valve (valve) 2, a host device 3, a controller 4, a positioner 1, and at least one sensor 5 (5_1 to 5_4), which is applied to, for example, a flow rate control process such as in a plant.

The control valve 2 is a device for controlling the flow of fluid from one flow path to another flow path. The control valve 2 includes an operating device 2A, a valve shaft 2B, and a valve (member) 2C. The operating device 2A is, for example, a pneumatic valve actuator that adjusts an opening (valve opening) of the valve (member) 2C by vertically moving the valve shaft 2B in accordance with a pressure of an output pneumatic signal (So) supplied from the later-described positioner 1.

The host device 3 is a host-side apparatus management system performing overall management of the valve control system 100, which is, for example, a distributed control system (DCS). The host device 3 is connected to the controller 4 and the positioner 1 through communication lines. For example, the host device 3 gives a target value SP of the valve opening of the control valve to the positioner 1 through the controller 4 and instructs execution of diagnosis of the control valve or the positioner itself by performing communications with the positioner 1. The host device 3, then, receives information of a diagnosis result and so on from the positioner 1.

The controller 4 is an apparatus that outputs a signal for instructing the positioner 1 to open/close the control valve 2 in accordance with, for example, an instruction from the host device 3. For example, the controller 4 gives an electrical signal indicating the target value (setting value) SP of the valve opening to the positioner 1 so that the control valve 2 is opened with a predetermined valve opening at the time of normal operation of the valve control system 100. The electrical signal is, for example, a current signal of 4 mA to 20 mA.

The sensors 5 (5_1 to 5_4) are devices for monitoring the peripheral environment of the control valve 2. The sensors 5 each have a function of detecting one physical quantity (a single sensor function) and are installed at positions where target physical quantities can be detected (for example, in the vicinity of the control valve 2 or on the outside of a casing of the control valve 2).

As the sensors 5, various sensors, such as a sensor for detecting gas leakage in the control valve 2 or a pipeline on the periphery thereof, a sensor for detecting a temperature of the control valve or on the periphery thereof, a sensor for detecting vibration in the control valve 2 and so on, and a sensor for detecting an abnormal noise in the control valve 2 and so on, can be cited as examples.

In the present specification, explanation will be made for a sensor 5_1 for detecting gas leakage, a sensor 5_2 for detecting vibration, a sensor 5_3 for detecting an abnormal noise, and a sensor 5_4 for detecting the temperature that are respectively arranged around the control valve 2 as an example. However, types and the number of sensors installed around the control valve 2 are not limited to the above example, and may be changed in various manners in accordance with a target to be monitored.

The respective sensors 5_1 to 5_4 are connected to the positioner 1 through a wireless channel. Each of the sensors 5_1 to 5_4 has a function unit (for example, a transmission/reception circuit, an antenna, and so on) for performing wireless communication with the positioner 1—for example, by wireless LAN (Local Area Network), short-range wireless communication, such as Bluetooth (registered trademark, the same shall apply hereinafter) or ZigBee (registered trademark, the same shall apply hereinafter), and so on.

Each of the sensors 5_1 to 5_4 has a D/A converter for converting an analog signal (for example, an output value of 0 to 5V) corresponding to the detected physical quantity into a digital signal, and transmits a sensor detection result converted into the digital signal by the D/A converter to the positioner 1 as information on the peripheral environment by wireless communication. The information on the peripheral environment transmitted from the respective sensors 5_1 to 5_4 to the positioner 1 includes not only the above sensor detection result but also identification information of the respective sensors, a sensor signal range, information in units of a sensor signal, and so on.

The positioner 1 controls opening/closing of the control valve 2 based on the target value SP of the valve opening of the control valve 2 given from the controller 4 and diagnoses the existence of a failure in the control valve 2 and the positioner 1 itself based on the instruction from the host device 3, transmitting the diagnosis result to the host device 3.

The positioner 1 performs wireless communication with the sensors 5_1 to 5_4 to acquire information on the peripheral environment from the sensors 5_1 to 5_4 and diagnoses the peripheral environment of the control valve based on the acquired information from the sensors 5_1 to 5_4, transmitting the diagnosis result of the control valve 2 or the positioner 1 itself to the host device 3.

Hereinafter, the positioner 1 will be explained in detail.

As shown in FIG. 1, the positioner 1 includes a data processing controller 10, communication units 11, 12, an electro-pneumatic converter 13, and a valve-shaft position detection unit 14.

The valve-shaft position detection unit 14 is a displacement amount detector that detects the valve opening of the control valve 2 as a displacement amount of the valve shaft 2B and that generates a detection signal SEN corresponding to the displacement amount. As the valve-shaft position detection unit 14, an angle sensor, a magnetic sensor, and so on can be cited as examples.

The electro-pneumatic converter 13 is a pneumatic circuit that converts an electrical signal MV generated by the later-described data processing controller 10 into a pneumatic signal. The electro-pneumatic converter 13 is formed of, for example, a nozzle flapper and a pilot relay. A supply air pressure of an air 6 supplied from an air pressure supply source (not shown), such as a pressure reducing valve provided on the outside of the positioner 1, is changed so as to correspond to the electrical signal MV by the nozzle flapper, thereby converting the supply air pressure into a pneumatic signal with a pressure corresponding to the electrical signal MV. The pneumatic signal is amplified by the pilot relay, thereby generating the output pneumatic signal So for driving the operating device 2A.

The communication unit 11 is a function unit for performing communication with the host device 3. The communication between the communication unit 11 and the host device 3 may be performed by wired communication, such as Ethernet (registered trademark) or HART communication, as well as by wireless communication. Communication systems and a circuit configuration of the communication unit 11 and so on are not particularly limited as long as transmission/reception of data can be performed.

The communication unit 12 is a function unit for performing communication with the respective sensors 5_1 to 5_4. The communication between the communication unit 12 and the respective sensors 5_1 to 5_4 is performed by wireless communication as described above, and the communication unit 12 has a transmission/reception circuit, an antenna, and so on for performing the wireless communication.

The data processing controller 10 is a function unit for performing control of the control valve 2, communication with the host device 3 and the sensors 5_1 to 5_4 through the communication units 11 and 12, and data processing relating to various diagnoses.

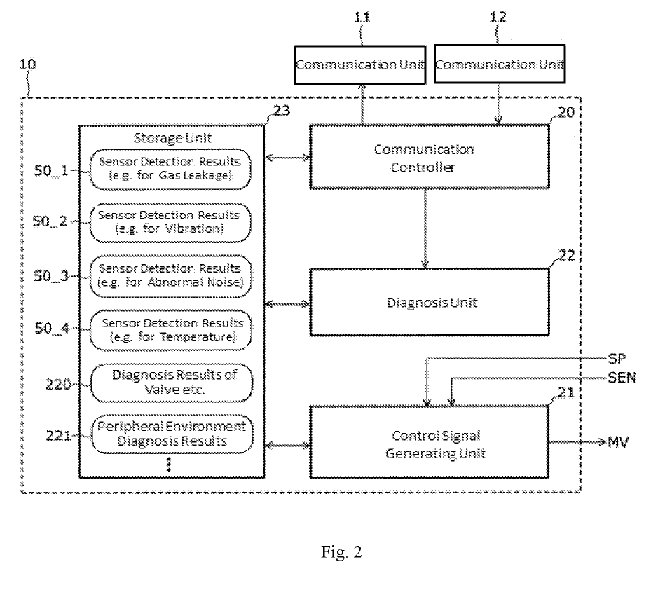

FIG. 2 is a diagram showing a configuration of the data processing controller 10.

In FIG. 2, function units necessary for the communication with the host device 3 and the sensors 5_1 to 5_4 and various diagnoses are chiefly shown in various function units included in the data processing controller 10, and function units for realizing other functions are not shown.

The data processing controller 10 is formed of hardware resources including a program processor, such as a micro controller (MCU) in which a CPU and various memories including a RAM, a ROM, and the like are mounted, and various interface circuits for realizing input and output of signals to the outside.

Specifically, the data processing controller 10 includes a communication controller 20, a control signal generating unit 21, a diagnosis unit 22 and a storage unit 23 as shown in FIG. 2. Here, the communication controller 20, the control signal generating unit 21, the diagnosis unit 22, and the storage unit 23 are realized by the hardware resources and programs (software) for realizing various functions in cooperation with the hardware resources.

The control signal generating unit 21 is a function unit for generating the electrical signal MV as a control signal for controlling the valve opening of the control valve 2. The control signal generating unit 21 calculates a deviation between the target value SP of the valve opening given from the controller 4 at the normal operation of the valve control system 100 and a measured value (PV) of the valve opening of the control valve 2 based on the detection signal SEN by the valve-shaft position detection unit 14, and generates the electrical signal MV corresponding to the deviation.

The diagnosis unit 22 is a function unit for performing diagnosis processing.

The diagnosis unit 22 performs various diagnosis processing in accordance with, for example, a timer (not shown) provided inside the positioner 1, an instruction from the host device 3 through the communication unit 11, an operation input to operation buttons (not shown) of the positioner 1 by a user, and so on to store diagnosis results in the storage unit 23.

As various diagnosis processing, valve diagnosis processing that determines the presence of a failure of the control valve 2, self-diagnosis processing that determines the existence of an abnormality of the positioner 1 itself, peripheral environment diagnosis processing that determines the existence of an abnormality in the peripheral environment of the control valve 2, and so on can be cited as examples.

The processing disclosed in above-described Patent Literatures 1, 2, and the like can be cited as examples of the valve diagnosis processing and the self-diagnosis processing. The diagnosis unit 22 stores diagnosis results by the valve diagnosis processing and the self-diagnosis processing in the storage unit 23 as diagnosis results of a valve and so on 220.

The peripheral environment diagnosis processing is performed based on information on the peripheral environment acquired from the respective sensors 5_1 to 5_4 by wireless communication. For example, the diagnosis unit 22 determines whether the amplitude of vibration exceeds a predetermined threshold value or not based on a sensor detection result 50_2 of the sensor 5_2 for detecting vibration, and determines that there exists an abnormality when the amplitude exceeds the threshold value. Also concerning the gas leakage, the presence of occurrence of an abnormal noise, the presence of an abnormality of temperature, and so on, the diagnosis unit 22 performs predetermined data processing based on sensor detection results from the respective sensors to thereby determine the presence of an abnormality in the same manner. The peripheral environment diagnosis processing by the diagnosis unit 22 is not limited to the above examples as long as the processing is performed based on respective sensor detection results 50_1 to 50_4.

The diagnosis unit 22 stores diagnosis results concerning the gas leakage, the presence of occurrence of abnormal vibration, the presence of occurrence of an abnormal noise, the presence of an abnormality of temperature, and so on, which have been performed based on the respective sensor detection results 50_1 to 50_4, in the storage unit 23 as peripheral environment diagnosis results 221.

The storage unit 23 is a function unit for storing data, such as the sensor detection results 50_1 to 50_4 received from the sensors 5_1 to 5_4, various parameters used for various diagnosis processing by the diagnosis unit 22, and various diagnosis results by the diagnosis unit 22. Such a function unit may be embodied by, for example, a hard disk apparatus, an optical disk apparatus, a solid state storage apparatus, and the like.

The communication controller 20 is a function unit for controlling communication with the host device 3 through the communication unit 11 and communication with the respective sensors 5_1 to 5_4 through the communication unit 12.

The communication controller 20 performs communication with the respective sensors 5_1 to 5_4 through the communication unit 12, for example, periodically or in accordance with an instruction from the host device 3 and so on, acquiring the sensor detection results 50_1 to 50_4 of the respective sensors 5_1 to 5_4, and storing the results in the storage unit 23.

The communication controller 20 gives an instruction to the later-described diagnosis unit 22 when receiving the instruction for various diagnoses outputted from the host device 3 through the communication unit 11.

Furthermore, the communication controller 20 transmits data stored in the storage unit 23 to the host device 3 through the communication unit 11.

For example, the communication controller 20 transmits the above-described diagnosis results of the valve and so on 220 by the diagnosis unit 22 and information concerning control of the control valve 2, such as the target value SP and the measured value PV of the valve opening, through the communication unit 11 to the host device 3 periodically or as a response with respect to the above-described instruction for executing various diagnosis processing from the host device 3. At this time, the communication controller 20 reads information concerning control of the control valve 2, the sensor detection results 50_1 to 50_4, and the peripheral environment diagnosis results 221 from the storage unit 23, and transmits the data through the communication unit 11 to the host device 3.

That is, the communication controller 20 transmits the sensor detection results 50_1 to 50_4 and the peripheral environment diagnosis results 221 to the host device 3 in synchronization with the timing when the information concerning the control of the control valve 2 is transmitted to the host device 3.

Next, the flow of transmission processing of the sensor detection results 50_1 to 50_4 and the peripheral environment diagnosis results 221 by the positioner 1 will be explained.

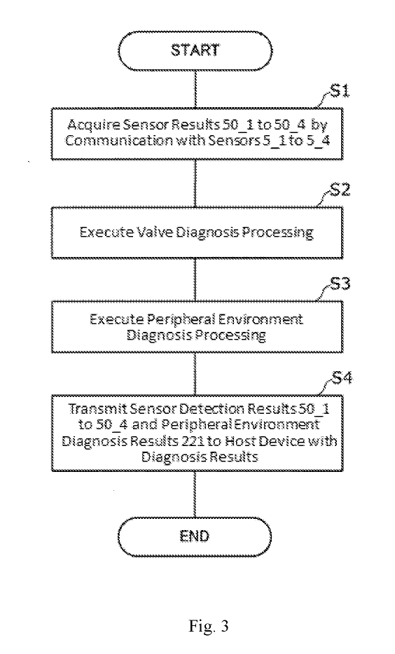

FIG. 3 is a flowchart showing the flow of transmission processing of the sensor detection results 50_1 to 50_4 and the peripheral environment diagnosis results 221 by the positioner 1 according to an embodiment of the invention. Here, explanation will be made by citing a case in which an instruction for performing the valve diagnosis processing is transmitted from the host device 3 to the positioner 1 as an example.

First, when the communication unit 11 receives an instruction for performing valve diagnosis processing from the host device 3 in the positioner 1, the communication unit 12 performs communication with the respective sensors 5_1 to 5_4 to acquire the sensor detection results 50_1 to 50_4 from the respective sensors 5_1 to 5_4, and the communication controller 20 stores the acquired data in the storage unit 23 (S1).

Next, the diagnosis unit 22 executes valve diagnosis processing and stores results as the diagnosis results of the valve and so on 220 in the storage unit 23 (S2) in the positioner 1. The diagnosis unit 22 also executes peripheral environment diagnosis processing by the above method and stores results as the peripheral environment diagnosis results 221 in the storage unit 23 (S3).

Next, the communication controller 20 reads information (the diagnosis results of the valve and so on 220 in this case) concerning control of the control valve 2 as well as the sensor detection results 50_1 to 50_4 and the peripheral environment diagnosis results 221 from the storage unit 23 and transmits the information to the host device 3 through the communication unit 11 in the positioner 1 as a response with respect to an instruction for executing valve diagnosis processing from the host device 3 (S4).

As described above, in the positioner 1 according to an embodiment of the present disclosure, the positioner 1 is allowed to function as a wireless base station in view of the fact that the positioner 1 is arranged in the vicinity of the control valve 2 at a close distance with respect to the respective sensors 5_1 to 5_4 installed around the control valve 2. Therefore, the positioner 1 acquires information of detection results of the respective sensors 5_1 to 5_4 and transmits the information after aggregating the information. Accordingly, it is not necessary that the respective sensors have communication functions corresponding to communication protocols requiring authentication, such as HART communication, and the increase of communication traffic in the communication with the host device 3 can be prevented. According to this, it is possible to prevent the sensors from being highly functional and high in costs as well as prevent the delay in an update cycle of information as compared with the case where the respective sensors 5_1 to 5_4 perform communication with the host device 3 independently.

As transmission/reception of data between the sensors 5_1 to 5_4 and the positioner 1 can be performed by wireless communication, it is not necessary to arrange the sensors 5_1 to 5_4 inside the positioner 1, and it is not necessary to worry about the review of the structure of the positioner and the increase of power consumption. Therefore, the increase of development man-hour and the like can be prevented. Moreover, it is not necessary to consider the routing of wiring in a peripheral area of the control valve 2 as compared with the case of performing communication by wired communication.

As described above, in the positioner 1 according to an embodiment of the present disclosure, it is possible to realize a system capable of collecting information on the peripheral environment of the control valve 2 and transmitting the information to the host device 3 efficiently at lower costs.

Also in the positioner 1 according to an embodiment of the present disclosure, the sensor detection results 50_1 to 50_4 acquired from the respective sensors 5_1 to 5_4 can be aggregated in the host device 3. Therefore, more advanced diagnosis services can be provided in the host device 3. For example, the above peripheral environment diagnosis is performed in the positioner 1 as a primary diagnosis, and an advanced secondary diagnosis considering the relevance between the control valve 2/the positioner 1 and the peripheral environment can be performed in the host device 3.

Also in the positioner 1 according to an embodiment of the present disclosure, communications with the respective sensors 5_1 to 5_4 can be performed through the positioner 1. Therefore, it is possible to construct a network by selecting desired sensors 5_1 to 5_4 by a user. Accordingly, for example, setting changes and so on of the sensors 5_1 to 5_4 can be performed from the host device 3 and so on. Therefore, improvement in maintainability in the field can be expected.

Furthermore, in the positioner 1 according to an embodiment of the present disclosure, the sensor detection results 50_1 to 50_4 and the peripheral environment diagnosis results 221 are transmitted to the host device 3 with information concerning control of the control valve 2. Therefore, further alleviation of congestion in communication traffic can be expected.

The invention made by present inventors has been specifically explained as the above based on an exemplary embodiment. However, the present disclosure is not limited to that, and it goes without saying that various alterations may occur within a scope not departing from the gist of the invention.

For example, the case where the diagnosis unit 22 performs peripheral environment diagnosis processing (primary diagnosis) based on the sensor detection results 50_1 to 50_4, and the peripheral environment diagnosis results 221 are transmitted to the host device 3 with the sensor detection results 50_1 to 50_4 has been cited as an example in the above embodiment. However, the present disclosure is not limited to this. For example, it is not always necessary that the diagnosis unit 22 perform peripheral environment diagnosis processing. In this case, only information of peripheral environment including the sensor detection results 50_1 to 50_4 is transmitted to the host device 3.

Also in the above embodiment, the case where the peripheral environment diagnosis results 221 are transmitted to the host device 3 in synchronization with the timing of transmitting the information concerning control of the control valve 2 has been cited as an example. However, it is also preferable that the positioner 1 transmit the sensor detection results 50_1 to 50_4 and the peripheral environment diagnosis results 221 to the host device 3 at one or more different timings from the timing of transmitting the information concerning control of the control valve 2 in the case where, for example, the increase of communication traffic is limited, such as when a delay in the updating cycle of information or the like does not occur.

Also in the embodiment, the case where the communication unit 12 performs communication with the respective sensors 5_1 to 5_4 to acquire information on the peripheral environment (respective sensor detection results 50_1 to 50_4) when the positioner 1 receives an instruction for executing various diagnoses transmitted from the host device 3 has been cited as an example. However, the present disclosure is not limited to this. For example, the communication unit 12 may acquire information on the peripheral environment by performing communication with the respective sensors 5_1 to 5_4 regardless of the presence or absence of reception of an instruction for executing various diagnoses. For example, it is preferable that the communication unit 12 starts communicating with the respective sensors 5_1 to 5_4 in accordance with a signal from a timer (for example, a timer of a microcomputer) inside the positioner 1 to acquire the respective sensor detection results 50_1 to 50_4, and it is also preferable that the communication unit 12 starts communicating with the respective sensors 5_1 to 5_4 in accordance with an operation input (an instruction for acquiring sensor detection results) with the respect to operation buttons of the positioner 1 by a user to acquire the respective sensor detection results 50_1 to 50_4.

### DESCRIPTION OF REFERENCE NUMERALS AND SIGNS

100 . . . valve control system, 1 . . . positioner, 2 . . . control valve, 2A . . . operating device, 2B . . . valve shaft, 2C . . . valve (member), 3 . . . host device, 4 . . . controller, 5, 5_1 to 5_4 . . . sensor, 6 . . . air, 10 . . . data processing controller, 11, 12 . . . communication unit, 13 . . . electro-pneumatic converter, 14 . . . valve-shaft position detection unit, SP . . . target value of valve opening, MV . . . electrical signal, So . . . output pneumatic signal, SEN . . . detection signal, 20 . . . communication controller, 21 . . . control signal generating unit, 22 . . . diagnosis unit, 23 . . . storage unit, 50_1 to 50_4 . . . sensor detection results, 220 . . . diagnosis results of valve and so on, 221 . . . peripheral environment diagnosis results

1. A control valve positioner, comprising:
an electro-pneumatic converter that converts an electrical signal for designating a valve opening of a control valve into a pneumatic signal and that supplies the pneumatic signal to an operating device of the control valve to operate a valve shaft of the control valve,
a valve-shaft position detection unit that detects a position of the valve shaft of the control valve;
a control signal generating unit that generates the electrical signal based on a target valve opening and the position of the valve shaft of the control valve detected by the valve-shaft position detection unit and that outputs the electrical signal to the electro-pneumatic converter;
a first communication unit performing communication with a host device;
a second communication unit performing communication with at least one sensor for monitoring a peripheral environment of the control valve by wireless communication; and
a communication controller connected to the first communication unit and the second communication unit, the communication controller controlling the first communication unit to transmit information on the peripheral environment acquired from the at least one sensor by the second communication unit through the first communication unit to the host device.

2. The control valve positioner according to claim 1,
wherein the communication controller controls the first communication unit to transmit the information on the peripheral environment to the host device along with information concerning control of the control valve.

3. The control valve positioner according to claim 2, further comprising:
a diagnosis unit performing diagnoses of the control valve,
wherein the information concerning control of the control valve includes diagnosis results by the diagnosis unit.

4. The control valve positioner according to claim 3,
wherein the diagnosis unit further diagnoses the peripheral environment of the control valve based on the information on the peripheral environment acquired by the second communication unit.

5. The control valve positioner according to claim 1,
wherein the communication controller controls the first communication unit to transmit the information on the peripheral environment to the host device in synchronization with a timing of transmitting information concerning control of the control valve to the host device.

6. The control valve positioner according to claim 5, further comprising:
a diagnosis unit performing diagnoses of the control valve,
wherein the information concerning control of the control valve includes diagnosis results by the diagnosis unit.

7. The control valve positioner according to claim 6,
wherein the diagnosis unit further diagnoses the peripheral environment of the control valve based on the information on the peripheral environment acquired by the second communication unit.

8. A valve control system comprising:
the positioner according to claim 1;
the control valve the valve opening of which is controlled by the pneumatic signal from the positioner;
the host device connected to the positioner via a communication line and performing transmission/reception of data with respect to the positioner; and
at the least one sensor connected to the positioner via a wireless channel and monitoring the peripheral environment of the control valve.
